(19) United States
(12) Patent Application Publication
(10) Pub. No.: US 2007/0244739 A1
(43) Pub. Date: Oct. 18, 2007

(54) Techniques for measuring user engagement

(75) Inventors: Francesca M. Soito, Milpitas, CA (US); Nitin Sharma, Mountain View, CA (US)

Correspondence Address: BEYER WEAVER LLP, P.O. BOX 70250, OAKLAND, CA, 94612-0250, US

(73) Assignee: YAHOO! INC.

(21) Appl. No.: 11/404,493

(22) Filed: Apr. 13, 2006

(51) Int. Cl. G06F 17/30

(52) U.S. Cl. 705/10

(57) ABSTRACT

Methods and apparatus are described for measuring engagement of a plurality of users with a product. User engagement data are generated representative of interaction with the product by the plurality of users. The user engagement data correspond to a plurality of user engagement variables. A user engagement score is generated for each of the plurality of users. Each user engagement score includes contributions corresponding to at least two of the user engagement variables for the corresponding user. Each contribution is weighted in accordance with at least one correlation among the plurality of user engagement variables.

### BACKGROUND OF THE INVENTION

The present invention relates to techniques for measuring user interaction with a wide variety of tools and applications and, more specifically, to techniques for providing more meaningful analyses of data representing such interaction.

The traditional metric used by web sites and web-based applications in measuring user engagement (and thus monitoring the “health” of the site or application) has been the number of page views by users during a given interval, e.g., a week or a month. This might be represented, for example, as shown in FIG. 1 in which page view data for a web-based mail application for a given month are segmented across three different user groups. In the example shown, the user segments, i.e., light, moderate, and heavy users, are defined by thresholds corresponding to arbitrarily selected numbers of page views. As can be seen, 64% of the page views in the month depicted were generated by the heavy user group, with 20% and 16% being generated by the moderate and light user groups, respectively.

It has been found that the data segmentation shown in FIG. 1 tends to remain fairly static over time even in the face of changes in the user population and the underlying application for which the data are being generated. So, in addition to being a fairly coarse representation of information, such data do not provide much in the way of meaningful insight.

Moreover, as online applications and services have become more sophisticated, the page view metric has become less useful as an indicator of user engagement. This is due, at least in part, to the fact that one of the primary goals of the designers of online tools and applications is to make them more efficient for users. That is, today's increasingly sophisticated tools and applications are intended to provide more functionality while requiring fewer actions (e.g., fewer page views) by users. Thus, the number of page views can be expected to correlate less over time with engagement.

In addition, increasingly sophisticated and experienced users tend to interact more efficiently with such tools and applications than less experienced users. So even though such users might be highly engaged with the tools and applications with which they interact, the page view metric, by itself, would not necessarily provide an accurate representation of their level of engagement.

In view of the foregoing, there is a need for better techniques for measuring user engagement with online tools and applications.

### SUMMARY OF THE INVENTION

According to the present invention, methods and apparatus are provided for measuring engagement of a plurality of users with a product. User engagement data are generated representative of interaction with the product by the plurality of users. The user engagement data correspond to a plurality of user engagement variables. A user engagement score is generated for each of the plurality of users. Each user engagement score includes contributions corresponding to at least two of the user engagement variables for the corresponding user. Each contribution is weighted in accordance with at least one correlation among the plurality of user engagement variables.

According to a more specific embodiment, the user engagement variables include a sessions variable, a time spent variable, and a user actions variable. The user engagement data include sessions data corresponding to the sessions variable and representing a number of sessions with the product for each of the plurality of users, time spent data corresponding to the time spent variable and representing time spent interacting with the product for each of the plurality of users, and user actions data corresponding to the user actions variable and representing a number of user actions by each of the plurality of users corresponding to the product.

A further understanding of the nature and advantages of the present invention may be realized by reference to the remaining portions of the specification and the drawings.

### BRIEF DESCRIPTION OF THE DRAWINGS

FIG. 1 is a representation of user engagement data generated using a conventional technique.

FIG. 2 is a flowchart illustrating a specific embodiment of the invention.

FIGS. 3A and 3B are representations of data for a first user engagement variable before and after the removal of outliers, respectively.

FIGS. 4A and 4B are representations of data for a second user engagement variable before and after the removal of outliers, respectively.

FIGS. 5A and 5B are representations of data for a third user engagement variable before and after the removal of outliers, respectively.

FIG. 6 shows two different plots of the results of a factor analysis using the data represented in FIGS. 3A-5B.

FIGS. 7-9 are segmentations of the data represented in FIGS. 3B, 4B, and 5B according to a specific embodiment of the invention.

FIG. 10 illustrates an exemplary segmentation of user engagement scores according to a specific embodiment of the invention.

FIG. 11 is a simplified network diagram illustrating at least some of the computing environments and platforms which may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to various embodiments of the present invention, techniques are provided for measuring and tracking user engagement with a product. As used herein, the term “product” denotes any tool or application (or suite or group of tools or applications) in any of a wide variety of computing contexts with which a population of users interacts. The tools or applications may be implemented in software and hardware. Examples of such tools and applications and the computing contexts in which embodiments of the invention may be implemented are discussed below.

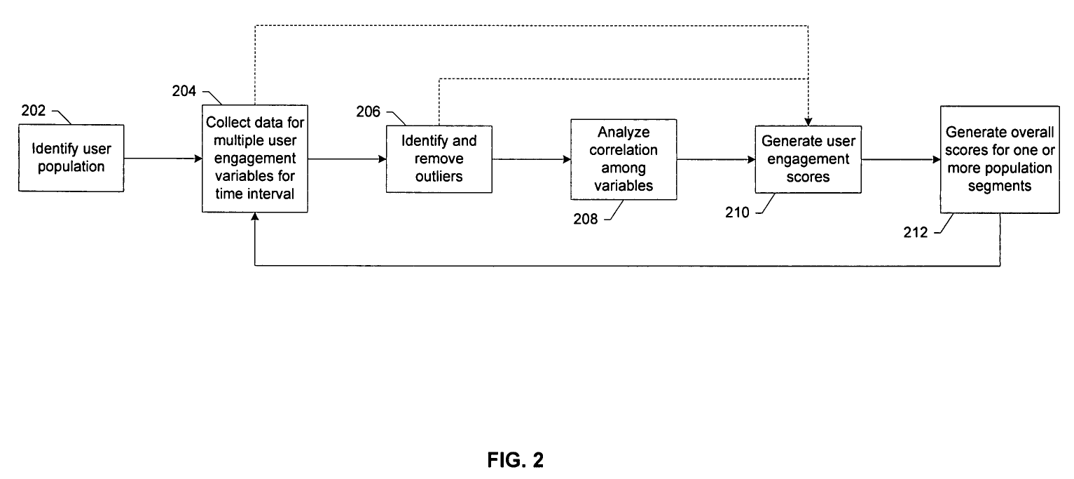

A specific embodiment of the invention will now be described with reference to FIG. 2. In this example, the product being evaluated is a web-based electronic mail application. It will be understood, however, that any reference to the mail application is for the purpose of illustrating the operation of a particular embodiment of the invention and should not be used to limit the scope of the invention. That is, the basic techniques described herein are applicable to virtually any software or hardware product for which user engagement data may be collected.

Initially, the population of users for which user engagement data will be collected is identified (202). This population might include all users of the product being evaluated. For the web-based mail application of this example, this could be each unique user as identified by a user name, login id, cookies, or some other mechanism. Alternatively, only a sample of a population of users might be used, e.g., users registered for a premium level of service associated with the mail application. It should also be understood that the user population may lose members and gain new members over time without departing from the invention.

Once the population of users is defined, data representative of user engagement are collected across the population for multiple user engagement variables (204). These data may be collected over any suitable time interval, e.g., days, weeks, months, etc. The data may also be averaged over multiple ones of such intervals (e.g., a monthly time spent interacting with a product for a given user might actually be an average of the time spent in 2 or more successive months). According to a specific embodiment described herein, such data are collected for three user engagement variables; the number of predefined user actions while interacting with the product, the number of sessions with the product, and the time spent interacting with the product.

The “user action” variable represents specific user interactions with the product for which user engagement is being measured. What is defined as a “user action” representative of user engagement may vary considerably depending on the product or the nature of the engagement being analyzed. For example, a user action for a conventional web site could be the number of pages viewed by the user. However, not all of the pages of a site may be suitably representative of user engagement. Therefore, some page views may be excluded from these data. That is, according to specific embodiments of the invention, only a subset of pages for a web site or application for which user engagement is being measured are selected to be recorded in the user action data based on a determination as to the extent to which the particular pages represent user engagement with the product.

In addition, page views themselves may not be particularly representative of user engagement for a product in which the user's interactions with the product do not typically result in the presentation of what is conventionally considered a page view. For example, the conventional conception of a page view is not particularly meaningful in the context of some types of applications, e.g., email or instant messaging applications. So, for such products, the user action variable could represent messages sent rather than pages viewed.

Other examples of user actions which may represent user engagement include, but are not limited to, the number of messages (e.g., email or instant) sent, received, or read, contacts in an address book, content downloads (e.g., songs), queries made, selections (e.g., clicks) of search results, news articles read, articles rated, products browsed, shopping cart adds, products compared, product pages viewed, quotes requested, reviews read, reviews posted, reviews forwarded, etc. In general, any user interaction with a product which is deemed representative of user engagement may be selected to be tracked in the user action data. In addition, more than one type of user action might be selected and tracked as part of the user action data.

The “sessions” variable represents the number of times a user returns to the product for which user engagement is being measured. Thus, a session might be counted, for example, each time a user directs her browser to a particular web site from a different, unrelated site (i.e., as opposed to browsing within a site). A session could also be counted each time a user logs on to a particular application, e.g., an email or messaging application. Alternatively, if a user is inactive for a predetermined time period (e.g., 30 minutes or more), then the current session could terminate and another session begin upon the next user action.

The “time spent” variable represents time spent by the user with the product. The time could be measured in any meaningful unit, e.g., seconds, minutes, hours, etc., and could represent all or only a portion of the time during which a user is engaged with or logged onto a particular application, or during which the application is open on the user's device. Any suitable timer mechanism for measuring or counting time may be employed. According to some embodiments, the time spent may only be counted where a user is currently interacting with the product as indicated by recorded activity. That is, if a certain amount of time passes without any user actions being recorded (thus indicating that the user is not currently interacting with the product), the accrual of time in this variable may terminate until a user action is detected.

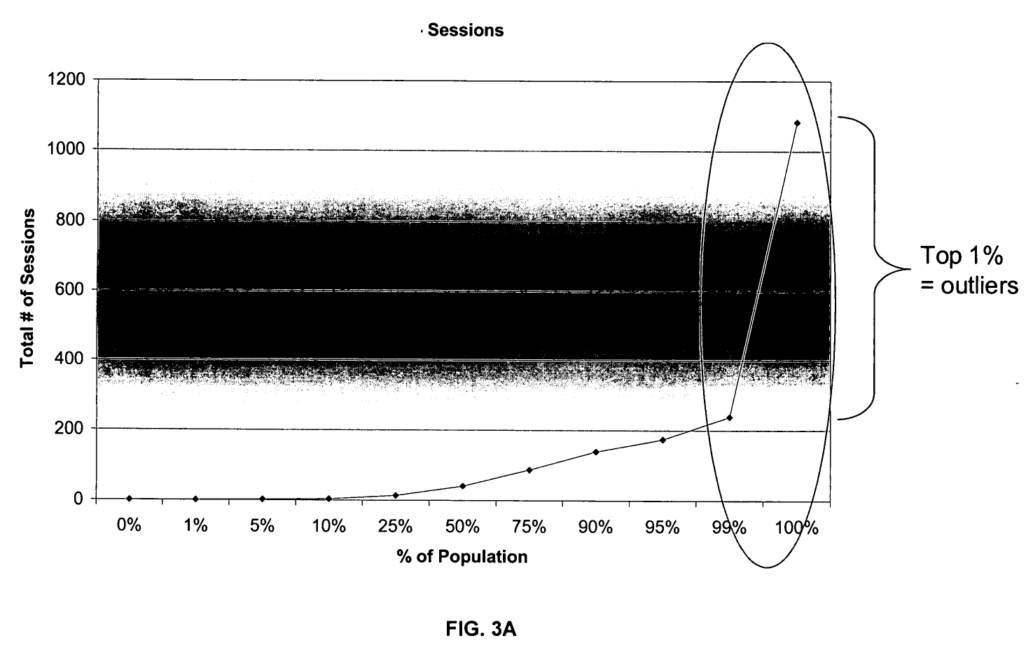

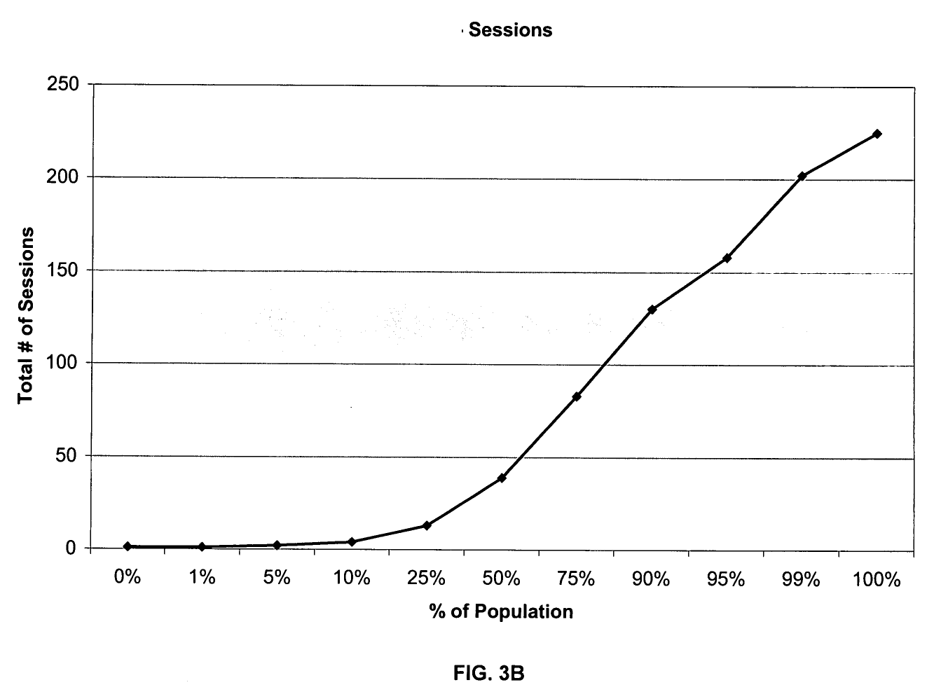

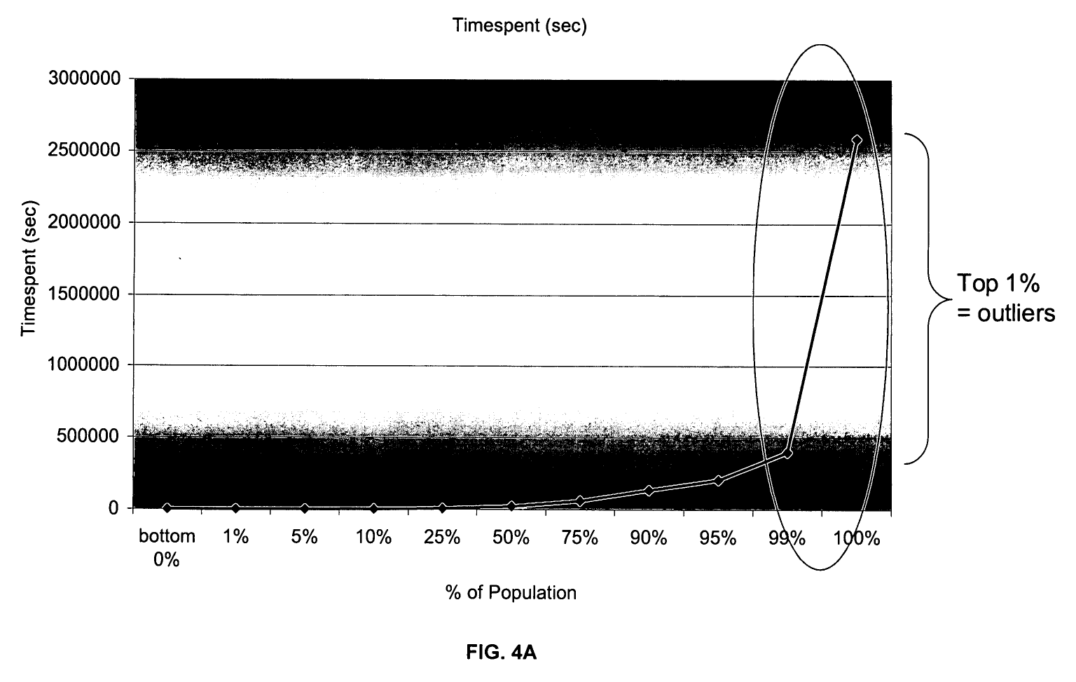

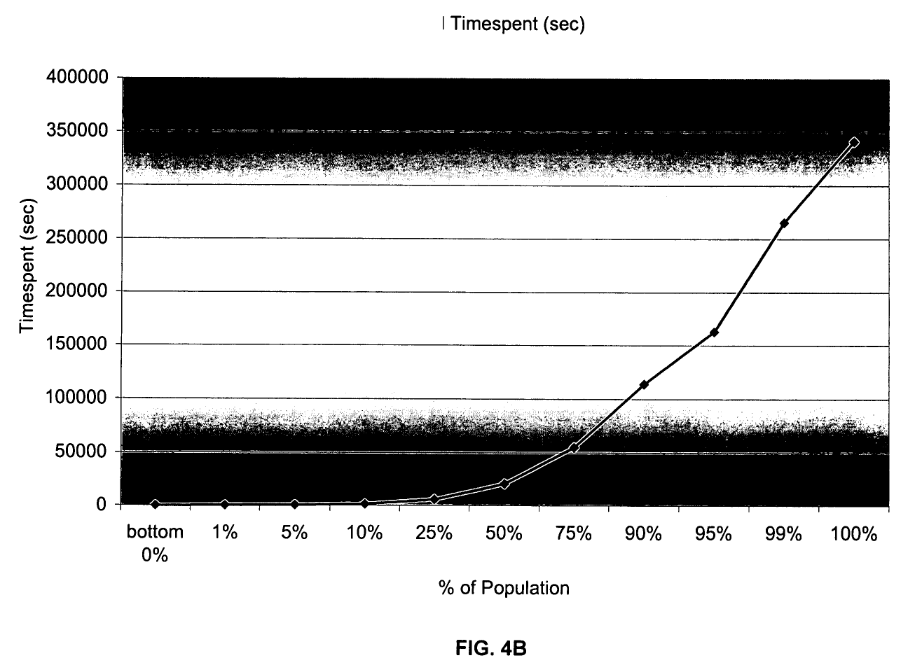

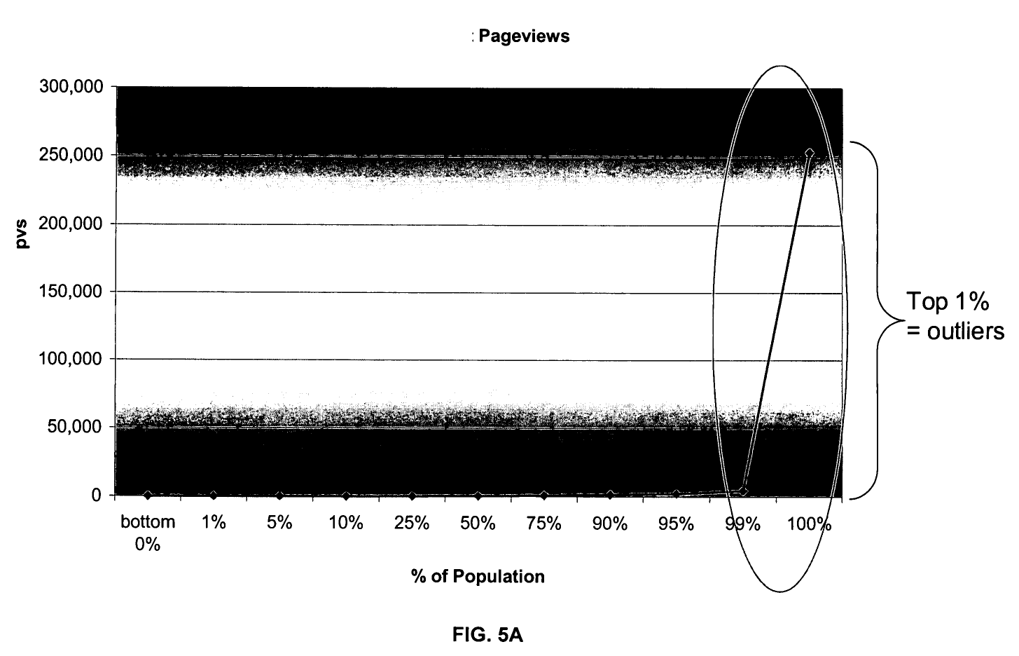

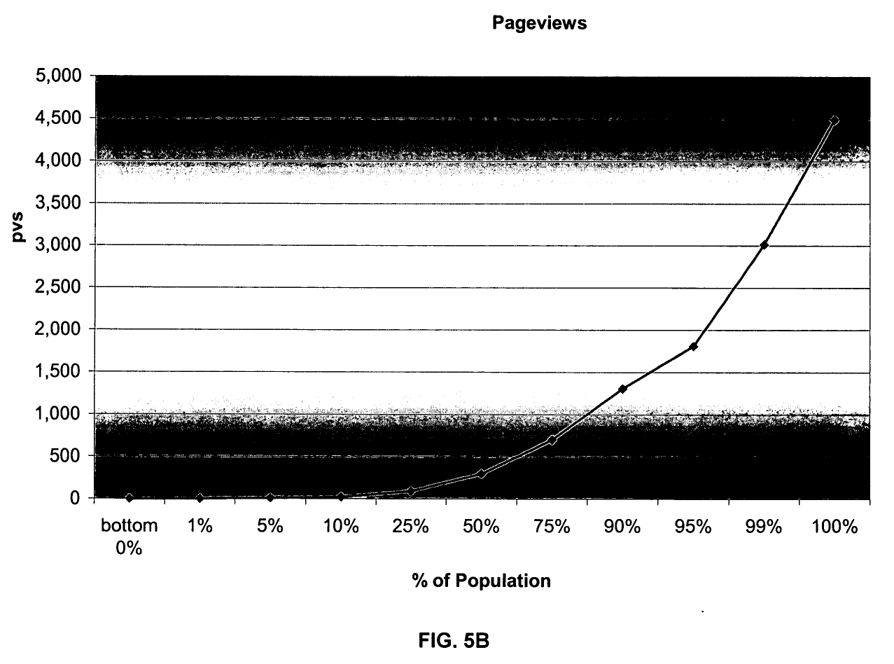

Referring once again to FIG. 2, once the user engagement data are collected for the relevant time period (e.g., a month in this example), data for each of the variables may optionally be segmented (e.g., by percentiles) to identify and remove outliers (206) as illustrated in FIGS. 3A-5B. FIGS. 3A, 4A, and 5A show the raw monthly data for each of the three variables, while FIGS. 3B, 4B, and 5B show the data with the outliers removed. It should be noted that the user action data in this example (FIGS. 5A and 5B) are referred to as “page views” as a simplification and that, as discussed above, these data may represent one or more of a wide range of user actions.

The user engagement data are analyzed to determine whether and to what extent the data for the different variables are correlated (208). Such an analysis may be accomplished using any of a variety of tools and techniques. For example, a standard factor analysis may be performed using suitable analytics software from providers such as SPSS Inc. of Chicago, Ill., or SAS Institute Inc. of Cary, N.C. The correlation between or among the user engagement variables may be used to determine how to weight the contributions of each of these variables to an overall user engagement score. An example of the determination of such an engagement score is discussed below.

It should be noted that, depending on the product and/or the user population being evaluated, the determination of the correlation among the user engagement variables may be performed once or only infrequently. That is, it is contemplated that for some products or user populations any such correlations may change only slowly over time, if at all. Thus, it is up to those performing the analysis to determine whether and how often this analysis should be repeated.

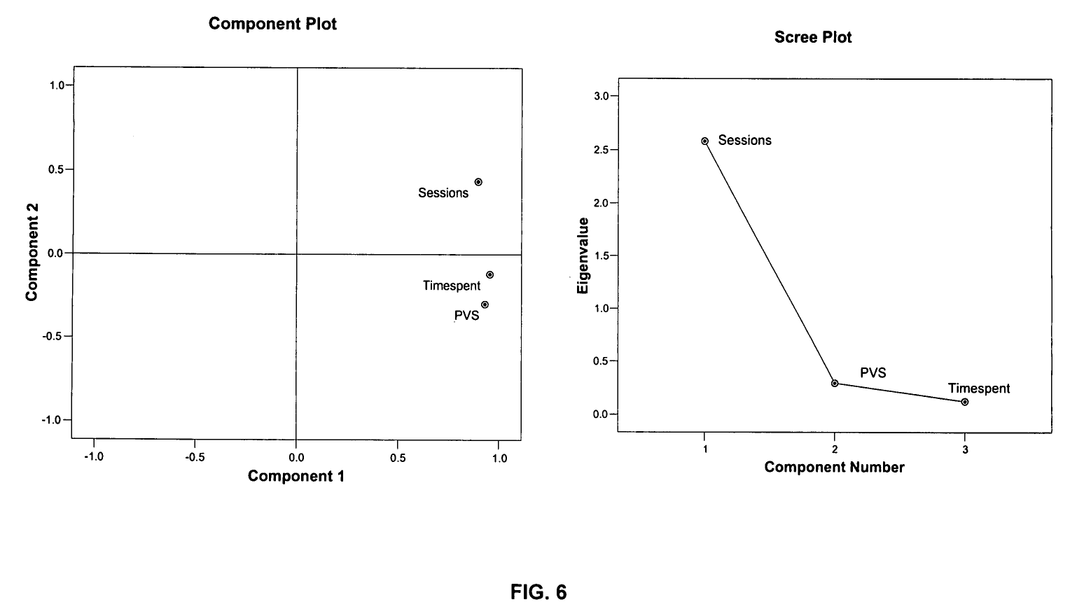

FIG. 6 shows exemplary results of a factor analysis using the data represented in FIGS. 3A-5B. As can be seen, in the exemplary application described herein, the time spent and user action (PVS) variables are highly correlated (e.g., they reside close together in the same quadrant of the component plot). In addition, the results of this factor analysis indicate that the only two of the three user engagement variables selected account for 96% of the variance in the data.

Once correlation among the various user engagement variables is understood, the user engagement data for the relevant time interval are used to generate a user engagement score for each user for that time interval (210), and possibly one or more overall user engagement scores for one or more segments of the user population for that time interval (212). Application of the user engagement scoring model may then be repeated for subsequent time intervals to track how user engagement with the product evolves over time, and for a variety of other purposes. As discussed above, these subsequent iterations may not necessarily include the determination of the correlation among the user engagement variables (as indicated by the dashed line bypassing 208). In addition, identification and removal of outliers may not necessarily be required (as indicated by the dashed line bypassing both 206 and 208).

Each user engagement score is some combination of contributions from multiple user engagement variables. As mentioned above, the contribution of each of the user engagement variables to the user engagement score is weighted in accordance with the level of correlation among the variables. According to the invention, the manner in which the user engagement data are combined, the weight attributed to the contributions from specific variables, the number of population segments for which scores are generated, and even the variables themselves may vary considerably without departing from the invention.

For example, according to some embodiments and depending on the level of correlation between and among the variables, the contribution of a particular variable to a user engagement score may be substituted for that of another variable with which it is highly correlated. Alternatively, the weighting of highly correlated variables may be adjusted to take into account the level of correlation. The latter approach might be more suitable than the former where, for example, there is some expectation that the correlation between the variables may change over time.

Other variables which might be employed to generate user engagement scores according to the invention include, for example, the number of “properties” adopted by users which are associated with a portal or the site of an ISP. For instance, a Yahoo! user might interact with many Yahoo! properties such as, for example, Yahoo! Mail, Yahoo! Messenger, Yahoo! News, My Yahoo!, Yahoo! Music, etc. Other variables might have financial components such as, for example, the amount of ad revenue each user generates, the number of premium services to which a user subscribes, etc. Tenure (e.g., length of time as a registered user) may also be used.

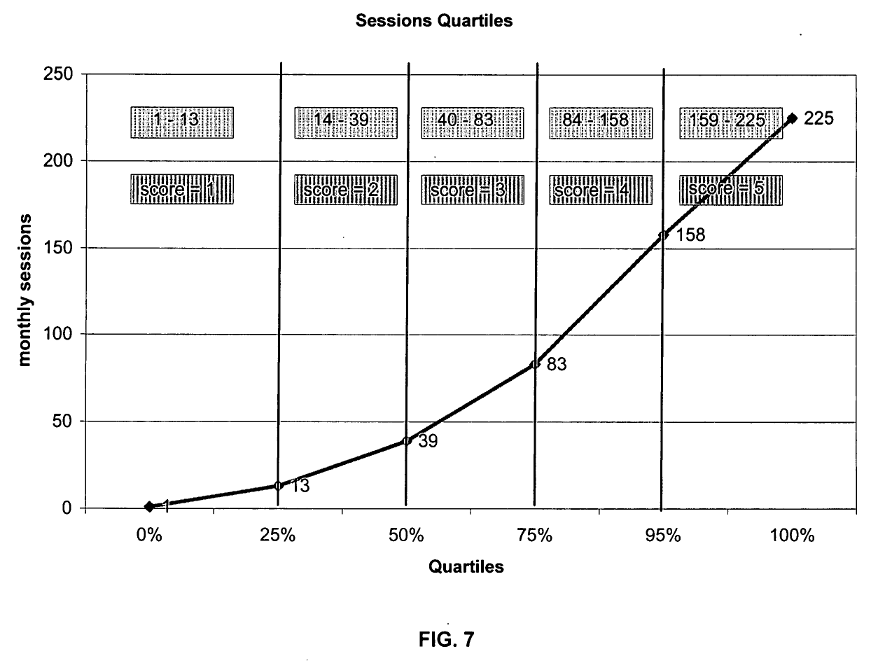

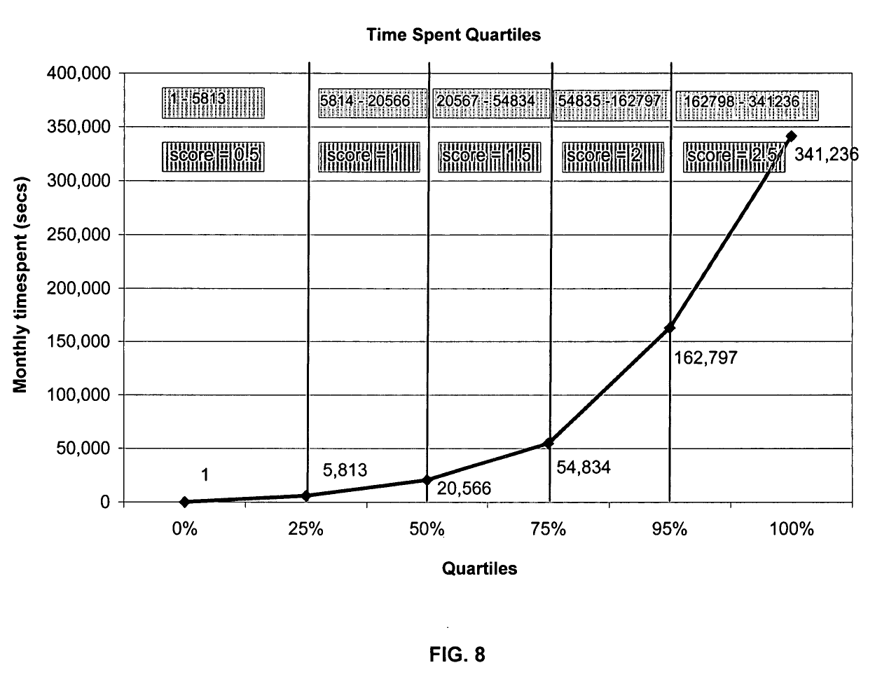

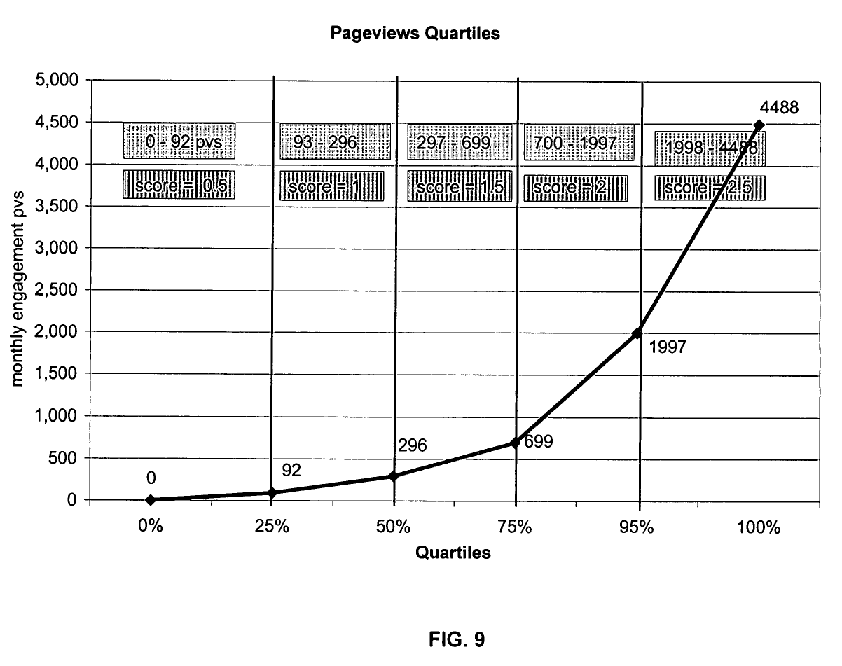

An example of how the contributions of multiple user engagement variables might be weighted and combined in practice is illustrated in FIGS. 7-9, and relates to the user engagement data represented in FIGS. 3A-5B and the correlation analysis results shown in FIG. 6. In these plots, the data collected for each of the variables are segmented into quartiles with the top quartile having the top 5% divided into an additional segment. The segment thresholds are plotted on the curve. Each segment is assigned a score by which the data in that segment are weighted.

As can be seen, in this example, the score contributions for the sessions variable are weighted twice as heavily as the contributions from either of the time spent and user action variables. This weighting is based on the high correlation between the latter two variables. And if, for example, a subsequent correlation analysis reveals a change in the correlation between these two variables, the weighting of their respective contributions may be adjusted accordingly.

The weighted contributions for each user are then combined into an overall score which represents each user's level of engagement with the product being evaluated. As mentioned above, the manner in which the weighted contributions are combined may vary depending on a variety of factors such as, for example, the nature of the product being evaluated, the nature of the population using the product, the information to be elicited from the analysis, and manner in which any of these factors evolves or is expected to evolve over time.

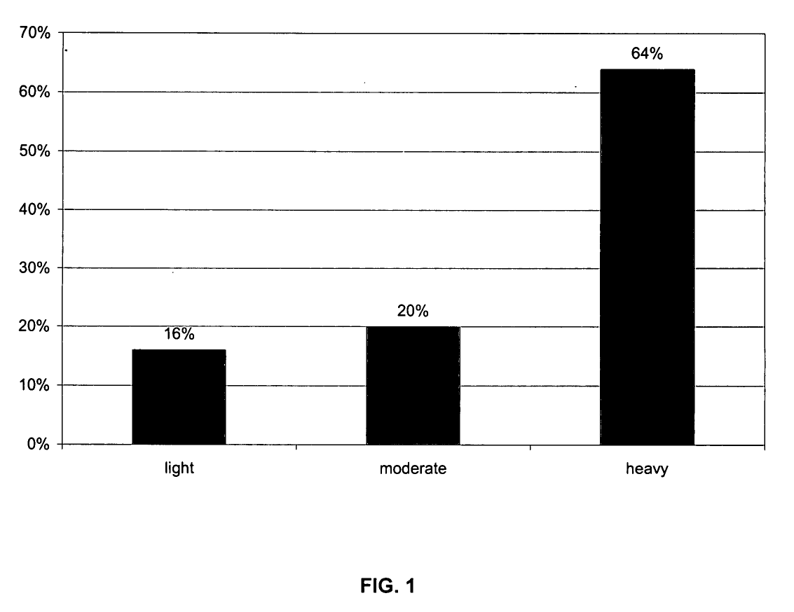

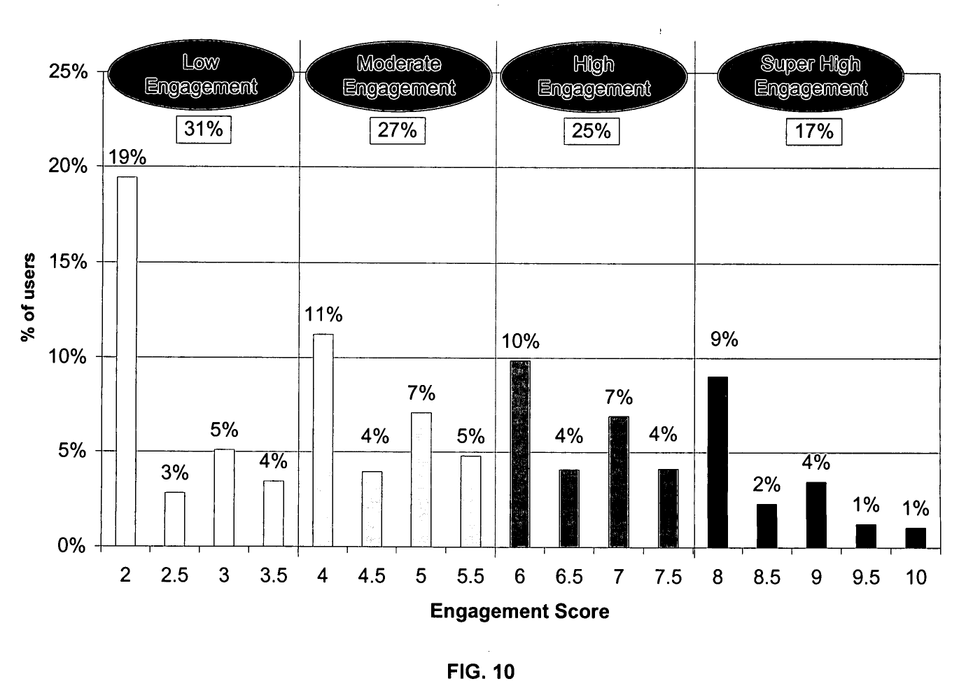

FIG. 10 illustrates a case in which the score contributions represented in the data of FIGS. 7-9 are simply added together to generate the overall user engagement score for each user. The possible user engagement scores (2-10) are plotted across the bottom of the graph against the percentage of users in the overall population corresponding to each score. In this example, the engagement scores are also grouped into four engagement level groups (low, moderate, high, and super high). As will be understood, the thresholds between these groups may be arbitrarily selected. When compared with the data representation shown in FIG. 1 (which represents the same user population and product for the same month), it is clear that the technique of the present invention provides a much more detailed and meaningful view of the level of user engagement.

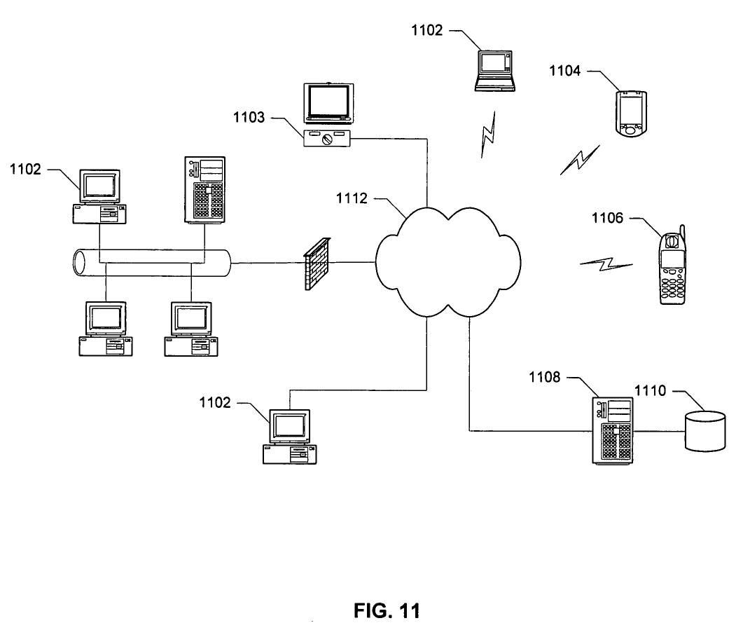

As mentioned above, the present invention may be employed to measure and track user engagement for virtually any product in any of a wide variety of computing contexts. For example, as illustrated in FIG. 11, implementations are contemplated in which the population of users interact with the product for which user engagement is being measured via any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform.

And according to various embodiments, user engagement data processed in accordance with the invention may be collected using a wide variety of techniques. For example, collection of data representing a user's interaction with a web site or web-based application or service (e.g., the number of page views) may be accomplished using any of a variety of well known mechanisms for recording a user's online behavior. However, it should be understood that such methods of data collection are merely exemplary and that user engagement data may be collected in many other ways. For example, user engagement data may be collected and cached on the user's device for subsequent transmission to a central repository for processing. Such an approach could be useful, for example, where user engagement with a product on a mobile device is being measured. It will also be understood that the mechanism for collecting the user engagement data may be embodied in the code of the product itself, as separate code, on the user's device, on a remote platform in communication with the user's device, or any combination thereof.

Once collected, the user engagement data are processed to generate some measure of user engagement according to the invention in some centralized manner. This is represented in FIG. 11 by server 1108 and data store 1110 which, as will be understood, may correspond to multiple distributed devices and data stores. The invention may also be practiced in a wide variety of network environments (represented by network 1112) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

As discussed above, the present invention enables the measurement and tracking of user engagement in a manner which provides deeper insight into the interaction of a population of users with a product. At one extreme, techniques designed in accordance with the present invention may be used to generate a single user engagement score which represents the level of engagement of the entire user population with the product being evaluated for the relevant time period. Such a score might be useful, for example, for presentation to a high level executive as an indicator of the “health” of the product and/or the corresponding business unit. It could be provided to such an executive in a desktop “dashboard” along with other information relating to the product and/or business unit.

Alternatively, a more granular segmentation (e.g., FIG. 10), may be useful to individuals or groups responsible for tracking trends in user engagement and devising strategies for moving user engagement in a desired direction, e.g., to grow the high and super high engagement groups of FIG. 10 faster than the low and moderate engagement groups. Such a segmentation could be useful, for example, to guide development of new product features and to evaluate whether new or existing features are having a desired effect.

Additional information, e.g., demographic information, which may be available for the user population may also be employed in conjunction with user engagement scores to better understand the user engagement segments and to develop strategies for improving user engagement. For example, if the low engagement segment of the user population has a high proportion of users corresponding to a particular demographic, new product features targeting that demographic may be introduced in an effort to increase the engagement of those users with the product. The present invention may also be used to identify certain types of users for the purpose of targeting those users with specific marketing or advertising opportunities. For example, users having engagement scores within a given range can be segmented and targeted for specific marketing or advertising campaigns. Such demographic information may include virtually any type of information including, for example, gender, socioeconomic status, tenure, online behavior metrics, property usage (e.g., page views generated on other properties), age, which country the user is in, etc.

While the invention has been particularly shown and described with reference to specific embodiments thereof, it will be understood by those skilled in the art that changes in the form and details of the disclosed embodiments may be made without departing from the spirit or scope of the invention. For example, embodiments have been discussed herein which relate to user engagement with software products. However, as mentioned above, user engagement with hardware could also be tracked and evaluated according to the invention. For example, user engagement with a handheld computing/communication device may be evaluated and scored using multiple variables which relate to the hardware features (e.g., keypads, touch screen, switches, etc.) with which the user interacts with the device. These data may be collected in real time, or cached for later transmission to some central location. Using the techniques described herein, the designers of such devices would be able to better understand how to improve the usability of their device based on improved insight into the engagement of their user population.

In addition, the product for which user engagement is being measured may include multiple tools or applications. For example, engagement with a portal, network, or ISP site which includes multiple tools, applications, and services could be measured and tracked according to the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for measuring engagement of a plurality of users with a product, comprising:
generating user engagement data representative of interaction with the product by the plurality of users, the user engagement data corresponding to a plurality of user engagement variables; and
generating a user engagement score for each of the plurality of users, each user engagement score including contributions corresponding to at least two of the user engagement variables for the corresponding user, wherein each contribution is weighted in accordance with at least one correlation among the plurality of user engagement variables.

2. The method of claim 1 wherein the user engagement variables include a sessions variable, a time spent variable, and a user actions variable, and wherein the user engagement data including sessions data corresponding to the sessions variable and representing a number of sessions with the product for each of the plurality of users, time spent data corresponding to the time spent variable and representing time spent interacting with the product for each of the plurality of users, and user actions data corresponding to the user actions variable and representing a number of user actions by each of the plurality of users corresponding to the product.

3. The method of claim 1 further comprising determining the at least one correlation among the plurality of user engagement variables using a factor analysis.

4. The method of claim 1 further comprising removing outliers from the user engagement data before generating the user engagement scores.

5. The method of claim 1 further comprising segmenting the user engagement scores into a plurality of user groups, each user group corresponding to a range of user engagement scores.

6. The method of claim 1 further comprising generating an overall engagement score from selected ones of the user engagement scores.

7. The method of claim 6 wherein the selected user engagement scores comprise all of the user engagement scores.

8. The method of claim 6 wherein the selected user engagement scores are defined by a range of the user engagement scores.

9. The method of claim 1 wherein the user engagement data and the user engagements scores are generated for a first time interval measured in any of seconds, minutes, hours, days, weeks, months, and years.

10. The method of claim 9 further comprising generating additional user engagement data and additional user engagement scores for at least one time interval subsequent to the first time interval.

11. The method of claim 1 wherein the product comprises one of a web site, a web-based application, stand-alone application, a client application, a distributed application, a peer-to-peer application, a group of applications, a portal, and a hardware device.

12. The method of claim 1 wherein the user engagement data are generated and stored locally with each user for subsequent transmission to a remote location for generation of the user engagement scores.

13. The method of claim 1 wherein the user engagement data are generated and stored remotely from the users as the users are interacting with the product.

14. The method of claim 1 further comprising analyzing the user engagement scores with reference to demographic data corresponding to the plurality of users.

15. A computer program product for measuring engagement of a plurality of users with a product, the computer program product comprising at least one computer-readable medium having computer program instructions stored therein which are operable to make at least one computer:
generate user engagement data representative of interaction with the product by the plurality of users, the user engagement data corresponding to a plurality of user engagement variables; and
generate a user engagement score for each of the plurality of users, each user engagement score including contributions corresponding to at least two of the user engagement variables for the corresponding user, wherein each contribution is weighted in accordance with at least one correlation among the plurality of user engagement variables.

16. The computer program product of claim 15 wherein the user engagement variables include a sessions variable, a time spent variable, and a user actions variable, and wherein the user engagement data including sessions data corresponding to the sessions variable and representing a number of sessions with the product for each of the plurality of users, time spent data corresponding to the time spent variable and representing time spent interacting with the product for each of the plurality of users, and user actions data corresponding to the user actions variable and representing a number of user actions by each of the plurality of users corresponding to the product.

17. The computer program product of claim 15 wherein the computer program instructions are further operable to make the at least one computer determine the at least one correlation among the plurality of user engagement variables using a factor analysis.

18. The computer program product of claim 15 wherein the computer program instructions are further operable to make the at least one computer remove outliers from the user engagement data before generating the user engagement scores.

19. The computer program product of claim 15 wherein the computer program instructions are further operable to make the at least one computer segment the user engagement scores into a plurality of user groups, each user group corresponding to a range of user engagement scores.

20. The computer program product of claim 15 wherein the computer program instructions are further operable to make the at least one computer generate an overall engagement score from selected ones of the user engagement scores.

21. The computer program product of claim 20 wherein the selected user engagement scores comprise all of the user engagement scores.

22. The computer program product of claim 20 wherein the selected user engagement scores are defined by a range of the user engagement scores.

23. The computer program product of claim 15 wherein the user engagement data and the user engagements scores are generated for a first time interval measured in any of seconds, minutes, hours, days, weeks, months, and years.

24. The computer program product of claim 23 wherein the computer program instructions are further operable to make the at least one computer generate additional user engagement data and additional user engagement scores for at least one time interval subsequent to the first time interval.

25. The computer program product of claim 15 wherein the product comprises one of a web site, a web-based application, stand-alone application, a client application, a distributed application, a peer-to-peer application, a group of applications, a portal, and a hardware device.

26. The computer program product of claim 15 wherein the user engagement data are generated and stored locally with each user for subsequent transmission to a remote location for generation of the user engagement scores.

27. The computer program product of claim 15 wherein the user engagement data are generated and stored remotely from the users as the users are interacting with the product.

28. The computer program product of claim 15 wherein the computer program instructions are further operable to make the at least one computer analyze the user engagement scores with reference to demographic data corresponding to the plurality of users.
